(19) United States
(12) Patent Application Publication
(10) Pub. No.: US 2013/0166627 A1
(43) Pub. Date: Jun. 27, 2013

(54) Clearing Locally Stored Objects Of A Browser Plugin

(71) Applicants: Jethro Villegas, San Francisco, CA (US); Rajesh Gwalani, Sunnyvale, CA (US)

(72) Inventors: Jethro Villegas, San Francisco, CA (US); Rajesh Gwalani, Sunnyvale, CA (US)

(73) Assignee: ADOBE SYSTEMS INCORPORATED, San Jose, CA (US)

(21) Appl. No.: 13/151,185

(22) Filed: Jun. 1, 2011

(51) Int. Cl. G06F 15/16

(52) U.S. Cl. 709/203

(57) ABSTRACT

Methods, systems, and apparatus, including computer programs encoded on a computer storage device, are described for browser plug-in functionality for clearing locally stored objects (LSOs). A described method includes providing a clear data interface of a plug-in program to a browser, the browser configured to call the clear data interface in response to a clear data event, obtaining, via the clear data interface, an indication of the clear data event; and deleting, based on the indication, one or more data objects (e.g., LSOs) stored by the plug-in program from a computer storage device. The clear data interface is able to be invoked regardless of whether an instance of the plug-in program is running.

### BACKGROUND

This patent document relates to clearing data objects stored by a browser plug-in program.

A client-server environment is a network architecture in which clients generally rely on servers for resources, such as files, databases, devices, processing power, etc. The World Wide Web and its associated web servers and web browsers are a typical example of a client-server environment using an existing underlying network (e.g., the Internet) for communications. Web browsers can be used to obtain and render pages of data, which are stored as a Hypertext Markup Language (HTML) documents. Moreover, web browsers can have plug-ins, which are added programs that introduce new functionality to the browser program. Such plug-ins can employ objects such as data objects, which can be read and written from within a given plug-in of the browser (e.g., a multimedia player, which can render streaming media flows from one or more servers).

### SUMMARY

This document describes technologies relating to browser plug-in functionality for clearing locally stored objects (LSOs). Various innovative aspects of the subject matter described in this document can be embodied in methods that include the actions of providing a clear data interface of a plug-in program to a browser, the browser configured to call the clear data interface in response to a clear data event; obtaining, via the clear data interface, an indication of the clear data event; and deleting, based on the indication, one or more data objects stored by the plug-in program from a computer storage device. In some implementations, the clear data interface is able to be invoked regardless of whether an instance of the plug-in program is running. Other embodiments of this aspect include corresponding systems, apparatus, and computer programs, configured to perform the actions of the methods, encoded on computer storage devices.

These and other embodiments can each optionally include one or more of the following features. Obtaining the indication can include receiving an indication of a time period. Deleting the one or more data objects can include selecting the one or more data objects based on the time period. Obtaining the indication can include receiving an indication of a site identifier. Deleting the one or more data objects can include selecting at least a portion of the one or more data objects based on the site identifier. Deleting the one or more data objects can include using a routine that is browser agnostic and operating system agnostic. Deleting the one or more data objects can include deleting a data object stored by a version of the plug-in program that is associated with a different browser. Deleting the one or more data objects can include deleting a data object storing one or more settings for the plug-in program. In some implementations, the clear data event is caused by a browser shutdown event. In some implementations, the clear data event is user-initiated.

A system can include a computer storage device; and a data processing device configured to run a browser and a plug-in program. The plug-in program can include instructions that when executed by the data processing apparatus cause the data processing apparatus to perform operations including providing a clear data interface to the browser, the browser configured to call the clear data interface in response to a clear data event, the clear data interface being able to be invoked regardless of whether an instance of the plug-in program is running, storing one or more data objects on the computer storage device, obtaining, via the clear data interface, an indication of the clear data event, and deleting, based on the indication, at least a portion of the one or more data objects.

A computer storage device can be encoded with a computer program, the program including instructions that when executed by data processing apparatus cause the data processing apparatus to perform operations. The operations can include providing a clear data interface of a plug-in program to a browser, the browser configured to call the clear data interface in response to a clear data event, where the clear data interface is able to be invoked regardless of whether an instance of the plug-in program is running; obtaining, via the clear data interface, an indication of the clear data event; and deleting, based on the indication, one or more data objects stored by the plug-in program from a computer-readable medium.

The details of one or more embodiments of the subject matter described in this document are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a flow chart showing an example of a process of clearing browser plug-in stored data objects.

FIG. 2 shows examples of browser data structures associated with browser plug-in programs.

FIG. 3 shows an example of a system in which clearing browser plug-in stored data objects is supported.

FIG. 4 is a flow chart showing another example of a process of clearing browser plug-in stored data objects.

Like reference numbers and designations in the various drawings indicate like elements.

### DETAILED DESCRIPTION

Web browsers can generate, retrieve, or modify data objects during a user's browsing session. Such data objects can be stored on a computer storage device. A data object can be referred to as a locally stored object (LSO). Moreover, web browsers can use one or more plug-in programs such as a multimedia player (e.g., FLASH® Player) during the session. The plug-in programs can also generate, retrieve, store, or modify data objects. For example, a user visits a site that supports interactive multimedia content (e.g., a FLASH® enabled site) and saves a data object. The browser uses a corresponding plug-in program (e.g., FLASH® Player) to handle the interactive multimedia content, which can retrieve the content and store the content as one or more data objects. The site (e.g., through a SWF file) can continue to cause the plug-in program to read and write to one or more data objects that are stored during the session. The data object can persist over one or more user sessions. For example, a plug-in program can store setting information in a data object associated with a site. The next time the user visits the site, the plug-in program can use the stored setting information to affect program behavior. Note that SWF is a file format, such as the SWF File Format Specification (Version 10) as published by Adobe Systems Incorporated of San Jose, Calif. The SWF file format delivers vector graphics, text, video, and sound over the Internet and is supported by Adobe® FLASH® Player and Adobe AIR™ software.

Data objects stored by plug-in programs can present concerns for user privacy. Thus, browser users should be able to manage their privacy, including being able to clear locally stored objects (LSOs) that are stored by plug-in programs, by using their browsers. Various examples of LSOs can include FLASH® content retrieved from a FLASH® enabled website and FLASH® Player settings for that particular website. Other types of LSOs are possible. Based on a technology described herein, a web browser can provide a central user interface (UI) location for managing privacy, such as a central UI button to clear not only browser cookies, but also local storage of plug-in programs. For example, a described technology can enable users of plug-in programs such as the Adobe® FLASH® Player, the ability to manage their privacy using a browser UI for clearing LSOs and perform on-demand clearing of LSOs.

A web browser can download and install plug-in programs. In some implementations, a plug-in program is a standalone program that is invoked by a web browser. In some implementations, a plug-in program is a software component written in a framework such as ActiveX. A clear data routine used by a clear data interface of a plug-in program can be agnostic to the type of browser and the type of operating system, for example, and clear data routine code can be re-used among different types of browsers.

A web browser configured with a plug-in application programming interface (PAPI) can use the PAPI to call a plug-in program interface for clearing LSOs generated/stored or retrieved/stored by the plug-in program. A web browser, via the PAPI and clear data enabled plug-in programs, can provide for an automatic way of clearing LSOs on a browser exit, UI support for a user-initiated clearing LSOs, or both. The web browser can provide a UI for clearing LSOs for a particular time period, for example, clearing LSOs created within the last hour, day, week, or month. The web browser can provide a UI for an on-demand clearing of LSOs for a specific site. In some implementations, clearing plug-in-program-produced LSOs in one browser can delete all LSOs on a computer storage device, even LSOs created by a different browser.

A data object stored by a program such as a browser or a plug-in program can include an electronic document or a portion thereof. An electronic document (which for brevity will simply be referred to as a document) may, but need not, correspond to a file. A document may be stored in a portion of a file that holds other documents, in a single file dedicated to the document in question, or in multiple coordinated files. In addition, a “browser” refers to any program that provides a user the ability to access a graphical representation of hyperlinked resources residing in disparate parts of a computer network, and is not limited to a standalone web browser application, such as Internet Explorer® software, Firefox® software, Safari® software, Chrome software, and Opera® software.

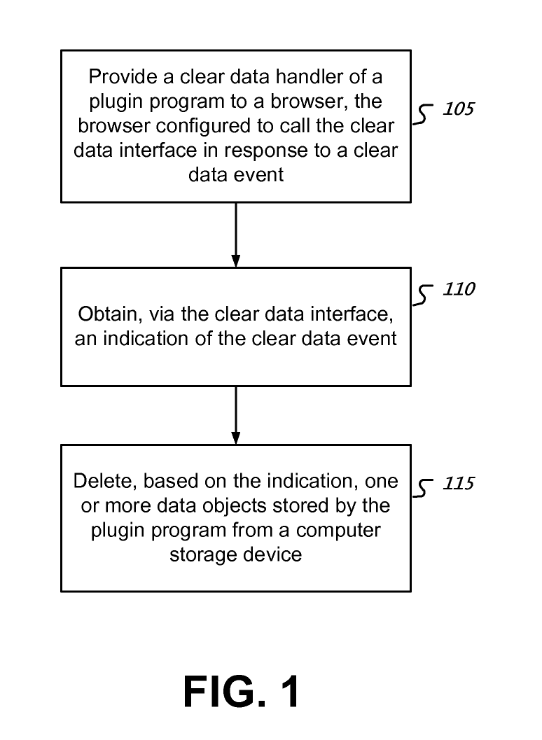

FIG. 1 is a flow chart showing an example of a process of clearing browser plug-in stored data objects. The process can be implemented by a data processing device. The process can be running within a web browser process or as a process separate from the web browser process. At 105, the process provides a clear data interface of a plug-in program to a browser. The browser is configured to call the clear data interface in response to a clear data event. In some implementations, the clear data interface is able to be invoked regardless of whether an instance of the plug-in program is running. Providing a clear data interface to a web browser can include providing an address of a function. The web browser can store the address and, later, use the address to call the clear data interface. When calling the clear data interface, a web browser can pass one or more values to the clear data interface.

In some implementations, a clear data interface does not require a plug-in instance. If a user selects to delete cookies from the browser UI and if the browser detects that a plug-in program is not running, the browser loads the plug-in program from disk (if not already loaded) without creating a plug-in instance, calls the plug-in initialization interface to retrieve a list of interfaces exposed by the plug-in program, and calls the clear data interface of the plug-in program. In some implementations, after calling the clear data interface, the browser calls a plug-in shutdown interface.

At 110, the process obtains, via the clear data interface, an indication of the clear data event. The indication can include deletion aspects such as a time period, or a site identifier, or both. For example, the clear data interface can delete data objects stored within an indicated time period. The clear data interface can delete data objects associated with an indicated site identifier. Other types of deletion aspects are possible. Obtaining the indication can include receiving one or more values (e.g., a time period, event type, site identifier, or a pointer to a value) from the web browser. The clear data event can be caused by a browser shutdown event. In some cases, the clear data event can be caused by a user input.

At 115, the process deletes, based on the indication, one or more data objects stored by the plug-in program from a computer storage device. In some implementations, deleting the one or more data objects includes selecting the one or more data objects based on a deletion time period. In some implementations, deleting the one or more data objects includes selecting one or more data objects based on an indicated site identifier and removing the selected data objects. Various examples of a computer storage device include flash memory devices, magnetic disks (e.g., disks in an internal hard drive of the computer system), and magneto optical disks (e.g., a re-writeable DVD-ROM disk).

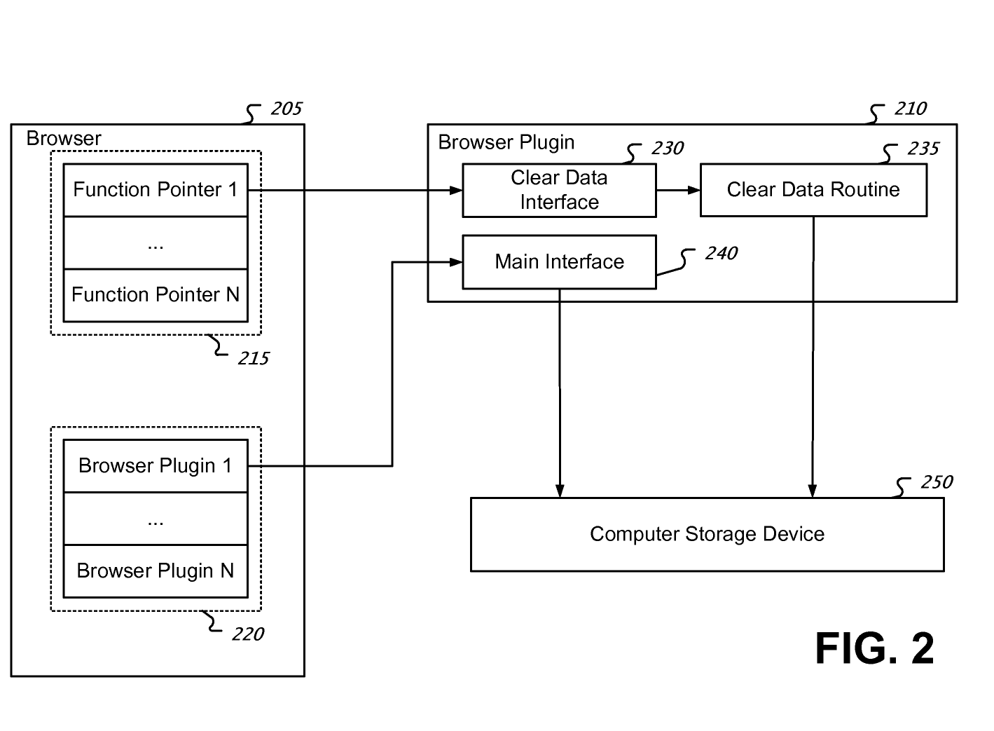

FIG. 2 shows examples of browser data structures associated with browser plug-in programs. A browser 205 can use one or more browser plug-ins 210 (only one plug-in is shown for simplicity). The browser 205 can use data structures 215, 220 to access various interfaces 230, 240 of a browser plug-in 210. Various examples of types of data structures 215, 220 include linked lists, hash tables, and trees. Other types of data structures are possible. In some implementations, based on a startup of the browser 205, the browser plug-ins 210 register the addresses of their interfaces 230, 240 with the browser 205 via a PAPI such as the Netscape Plug-in Application Programming Interface (NPAPI).

The browser plug-in 210 can include a clear data interface 230, a clear data routine 235, and a main interface 240. A memory area allocated to the browser 205 can include a data structure 215 that contains function pointers to clear data interfaces 230 of respective browser plug-ins 210. The memory area allocated to the browser 205 can include another data structure 220 with information about browser plug-ins, such as function pointers to the main interfaces 240 of respective browser plug-ins 210.

The browser 205 can invoke the main interface 240 of a browser plug-in 210 to handle one or more types of content, such as FLASH® content. The main interface 240 can retrieve content from a network. The main interface 240 can store the retrieved content on a computer storage device 250 as a LSO. In some implementations, the main interface 240 can store plug-in settings (e.g., user preferences, display settings, or audio settings) on the computer storage device 250.

The browser 205 can cause data to be cleared from the computer storage device 250 based on a clear data event. A clear data event can be generated based on an event such as a browser shutdown signal or a user input. Other types of clear data events are possible. The browser 205, for example, can display a “Clear Data” button, that when selected, causes the browser 205 to call all of the clear data interfaces 230 via function pointers that are listed in a data structure 215 of the browser 205. In some implementations, the browser 205 can provide information such as an event type value (e.g., a clear data event type value) to the clear data interface 230. In some implementations, the browser 205 can retrieve information from the clear data interface 230, such as details on what objects are stored on the computer storage device 250 by the browser plug-ins 210. The details can include a site identifier, a timestamp, type of data object, or a combination thereof. These details can be displayed to a user in a window of the browser 205. The browser 205 can receive an input that indicates site identifiers selected for deletion, which are provided to an associated clear data interface 230. The clear data interface 230 can delete objects associated with the provided site identifiers. The clear data interface 230 can use a clear data routine 235 to clear data from the computer storage device 250. The clear data interface 230 and the clear data routine 235 can be operating system and browser agnostic; with the clear data interface 230 being operating system agnostic and an implementation of the clear data routine 235 being browser agnostic. In some cases, code for a browser agnostic clear data routine 235 can be used for multiple types of browsers, operating systems, or both. In some implementations, the clear data interface 230 includes the clear data routine 235.

A web browser can configure one or more internal data structures for access to one or more interfaces of a plug-in such as a clear data interface or a main interface. A web browser can load one or more browser plug-in programs in to a browser process. The process is assigned by a computer system for the plug-in program to run in, and the process can be shared by multiple running programs (e.g., multiple instances of the same plug-in program) or be dedicated to the running plug-in program (e.g., a process in a multi-tasking operating system assigned solely to a specific instance of the plug-in program). In some cases, the web browser is not required to load a plug-in in order to invoke an interface of the plug-in such as a clear data interface.

In an instance of a plug-in program initiated within the process, code can be received from a site that creates a LSO or downloads data from a site and caches the data as a LSO. For example, a LSO can include data such as multimedia data, audio data, video data, program code, or a combination thereof. In some implementations, a plug-in program can generate data locally and store the data as a LSO.

In some implementations, a LSO can include state information for a running program, information about a user of the browser, information about user interactions with the browser, or a combination of these. The plug-in program can provide an execution environment in which one or more additional programs (e.g., bytecode) can run. In some implementations, these additional programs can be designed to generate local data in the course of operation that should be saved locally (e.g., at the computer system running the additional programs) for later use or sharing with other additional programs. Moreover, other types of LSOs can be saved in response to information received by the instance of the plug-in program initiated within the process, such as cached video or audio data in the case of the plug-in program including a multimedia player.

A clear data interface of a plug-in program can obtain an indication from a web browser. The obtaining can include receiving the indication (e.g., receiving data pushed to the plug-in by a web browser) or actively retrieving the indication (e.g., calling an API to obtain the indication). The indication can be data specific to a given browser (e.g., a return result from a call to a browser-specific API) or data defined by a standard used by multiple browsers. Moreover, the plug-in program can be designed to pursue more than one approach to obtaining the indication to maximize compatibility with multiple different browser programs.

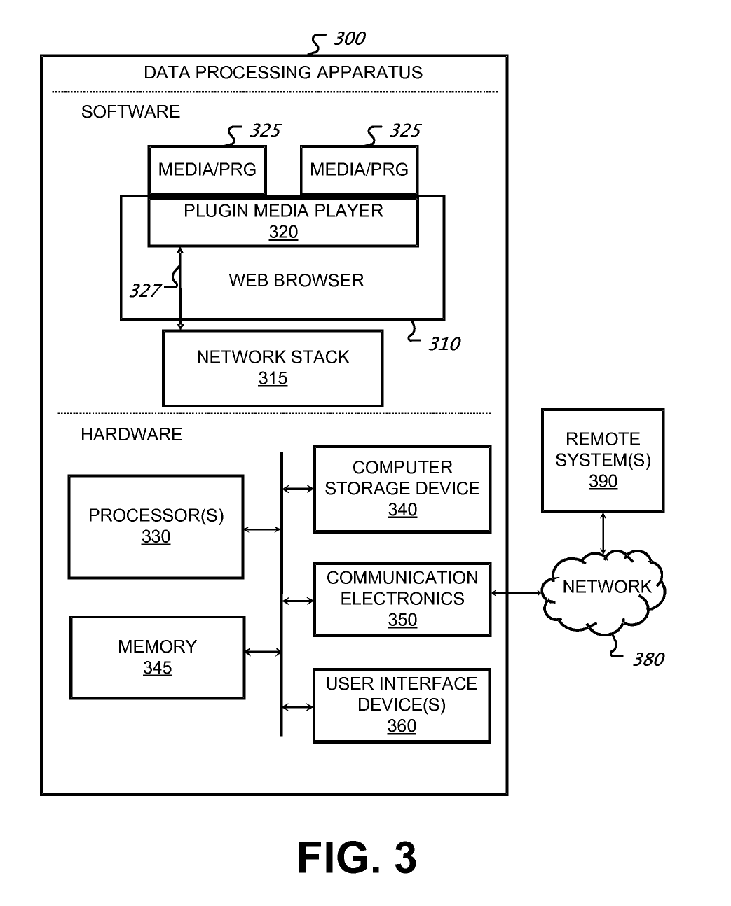

FIG. 3 shows an example of a system in which clearing browser plug-in stored data objects is supported. A data processing apparatus 300 includes hardware/firmware, which provides the hardware platform, and software that runs on this hardware platform. The data processing apparatus 300 includes one or more processors 330 and at least one computer storage device 340. The data processing apparatus 300 can also include a communication electronics 350, and one or more user interface devices 360.

The communication electronics 350 provides access to one or more remote systems 390 (e.g., a server farm for a website) over a data communication network 380 (e.g., the Internet). Access to the communication electronics 350 can be provided to various programs through a network stack 315, which represents one or more pieces of networking software implementing various networking protocols. The network stack 315 can be built into an operating system of the apparatus 300 or be a separate program.

The user interface device(s) 360 can include display screen(s), keyboard(s), mouse, stylus, other user input/output devices, or any combination thereof. Moreover, the data processing apparatus 300 can itself be considered a user interface device. Thus, the apparatus 300 represents multiple types of computing systems, including, for example, a personal computer running a web browser or a mobile telephone running a Wireless Application Protocol (WAP) browser.

The software includes a web browser 310 that uses the network stack 315 to access resources on the network 380. The web browser 310 includes a plug-in media player 320, which is designed to process and display multimedia data (e.g., video, audio, and graphics data) within the web browser 310. The plug-in media player 320 can define an execution environment that allows creation and presentation of user interface elements, storage and processing of LSOs, and other operations by multiple programs 325, which can be included with media data provided to the plug-in media player 320 for rendering to a display device 360.

The execution environment of the plug-in media player 320 can be a virtualization environment that works in conjunction with native services (e.g., an operating system) of the data processing apparatus 300 to provide a consistent well-defined environment in which programs can be loaded and executed. The execution environment can include facilities such as memory management (e.g., garbage collection), standard libraries, media decoders, user interface frameworks and input-output interfaces. Note that a program designed to run within an execution environment can often be developed rapidly because developers can rely on the consistency of the execution environment—even if the environment itself exists on widely varying hardware platforms.

In addition, the programs 325 can be provided in the form of an encoded representation having a predefined syntactic structure such as a programming language (e.g., source code) or can include well defined virtual instructions (e.g., platform-independent bytecode, such as Macromedia FLASH® bytecode). The execution environment of the plug-in media player 320 can decode the encoded representation of the program 325 into instructions and can execute the instructions of the program 325. When the execution environment of the plug-in media player 320 is designed as a virtualization environment in this manner, it can also be referred to as an interpreter or virtual machine. In addition, such an execution environment often includes a runtime library that provides various utility services (e.g., string manipulation, networking, graphics, addressing peripherals, or other types of functionality) for use by the programs 325.

An instance of the plug-in media player 320 can be loaded by the web browser 310 in to a memory 345. In some implementations, an instance of the plug-in media player 320 is not required to be loaded in memory 345 in order for the web browser 310 to invoke a clear data interface of the plug-in media player 320. The plug-in media player 320 can cache data on the computer storage device 340. In some implementations, plug-in media player 320 uses a file path that is specific to the plug-in media player 320. The plug-in specific file path can be the same for various versions of the plug-in media player 320. For example, a version for the Firefox® web browser of the player 320 and a version for the Internet Explorer® of the player 320 can use the same file path to cache data. For example, both versions write to the same directory in a file system encoded on a computer storage device; and the clear data routine deletes all files in that directory. In some implementations, a LSO includes a data object created by the plug-in media player 320. In some cases, one or more LSOs can be used to manage player settings and user content settings for the plug-in media player 320.

The player settings can correspond to default settings for the plug-in media player 320 overall, and the user content settings correspond to user specified settings for particular accessed resources. Both types of settings can be scoped to domains (e.g., the top level domain of a website accessed over the Internet), and settings can be written based on the domain that the content was served from, where web content from a default domain (e.g., the domain of the software provider for the plug-in media player 320) can be treated as preferred for the plug-in media player 320. In some media player implementations, web content can never apply settings for the plug-in, and users can modify settings for a specific domain using the control panel provided by the media player using the settings UI and settings manager panels.

The web browser 310 can provide a UI based Settings Manager for letting a user manage global privacy settings, storage settings, security settings, and automatic notification settings by using one or more panels. In some implementations, the web browser can invoke a plug-in program UI based panel or window for managing settings that are specific to a plug-in program. The Settings Manager can provide a user-selectable option for removing LSOs on browser shutdowns. Moreover, the Settings Manager can provide a user-selectable option for viewing LSOs stored by installed plug-in programs.

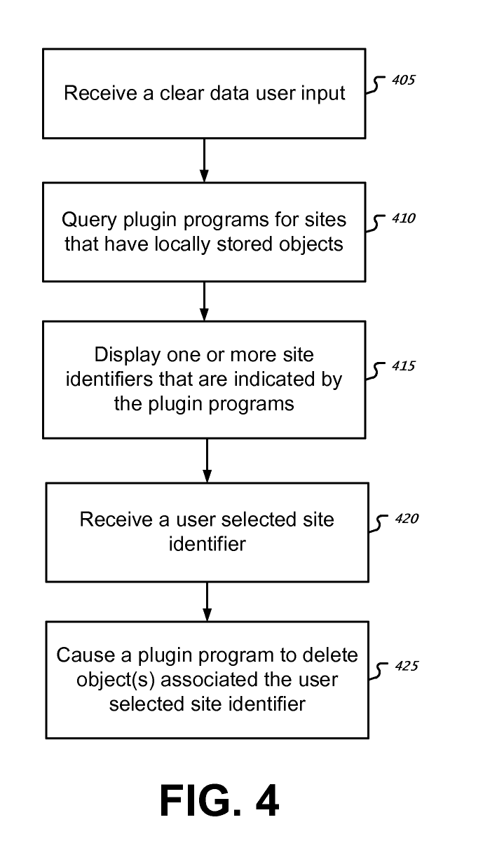

FIG. 4 is a flow chart showing another example of a process of clearing browser plug-in stored data objects. At 405, the process receives a clear data user input. For example, the process can receive a user selection of a menu button labeled “Clear Site Data.” At 410, the process queries plug-in programs for sites that have locally stored objects. Querying a plug-in program can include calling a clear data interface of the plug-in program. At 415, the process displays one or more site identifiers that are indicated by the plug-in programs. A site identifier can include an address of a site (e.g., www.XYZ.com). In some implementations, a site identifier can include a value that corresponds to a particular site (e.g., the value of “1” corresponds to “www.XYZ.com”).

At 420, the process receives a user selected site identifier. Receiving a user selected site identifier can include receiving an indication of a user selection of a displayed site identifier by way of a device such as a pointer device or a touch sensor of a touch screen. At 425, the process causes a plug-in program to delete object(s) associated the user selected site identifier. Causing a plug-in program to delete objects can include passing one or more site identifiers to a clear date interface of the plug-in program. A clear date interface can include one or more sub-interfaces, e.g., a sub-interface for retrieving site identifiers, or a sub-interface for deleting objects associated with specific site identifiers, or both. Other sub-interfaces are possible.

Embodiments of the subject matter and the operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources. The term “data processing apparatus” encompasses all kinds of apparatus, devices, and machines for processing data, including by way of example a programmable processor, a computer, a system on a chip, or multiple ones, or combinations, of the foregoing The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

What is claimed is:

1. A method performed by data processing apparatus, the method comprising:
providing a clear data interface of a plug-in program to a browser, the browser configured to call the clear data interface in response to a clear data event, wherein the clear data interface is able to be invoked regardless of whether an instance of the plug-in program is running;
obtaining, via the clear data interface, an indication of the clear data event; and
deleting, based on the indication, one or more data objects stored by the plug-in program from a computer storage device.

2. The method of claim 1, wherein obtaining the indication comprises receiving an indication of a time period, and wherein deleting the one or more data objects comprises selecting the one or more data objects based on the time period.

3. The method of claim 1, wherein obtaining the indication comprises receiving an indication of a site identifier, and wherein deleting the one or more data objects comprises selecting at least a portion of the one or more data objects based on the site identifier.

4. The method of claim 1, wherein deleting the one or more data objects comprises using a routine that is browser agnostic and operating system agnostic.

5. The method of claim 1, wherein deleting the one or more data objects comprises deleting a data object stored by a version of the plug-in program that is associated with a different browser.

6. The method of claim 1, wherein deleting the one or more data objects comprises deleting a data object storing one or more settings for the plug-in program.

7. The method of claim 1, wherein the clear data event is caused by a browser shutdown event.

8. The method of claim 1, wherein the clear data event is user-initiated.

9. A computer storage device encoded with a computer program, the program comprising instructions that when executed by data processing apparatus cause the data processing apparatus to perform operations comprising:
providing a clear data interface of a plug-in program to a browser, the browser configured to call the clear data interface in response to a clear data event, wherein the clear data interface is able to be invoked regardless of whether an instance of the plug-in program is running;
obtaining, via the clear data interface, an indication of the clear data event; and
deleting, based on the indication, one or more data objects stored by the plug-in program from a computer-readable medium.

10. The device of claim 9, wherein obtaining the indication comprises receiving an indication of a time period, and wherein deleting the one or more data objects comprises selecting the one or more data objects based on the time period.

11. The device of claim 9, wherein obtaining the indication comprises receiving an indication of a site identifier, and wherein deleting the one or more data objects comprises selecting at least a portion of the one or more data objects based on the site identifier.

12. The device of claim 9, wherein deleting the one or more data objects comprises using a routine that is browser agnostic and operating system agnostic.

13. The device of claim 9, wherein deleting the one or more data objects comprises deleting a data object stored by a version of the plug-in program that is associated with a different browser.

14. The device of claim 9, wherein deleting the one or more data objects comprises deleting a data object storing one or more settings for the plug-in program.

15. The device of claim 9, wherein the clear data event is caused by a browser shutdown event.

16. The device of claim 9, wherein the clear data event is user-initiated.

17. A system comprising:
a computer storage device; and
a data processing device configured to run a browser and a plug-in program, wherein the plug-in program comprises instructions that when executed by the data processing apparatus cause the data processing apparatus to perform operations comprising (a) providing a clear data interface to the browser, the browser configured to call the clear data interface in response to a clear data event, the clear data interface being able to be invoked regardless of whether an instance of the plug-in program is running, (b) storing one or more data objects on the computer storage device, (c) obtaining, via the clear data interface, an indication of the clear data event, and (d) deleting, based on the indication, at least a portion of the one or more data objects.

18. The system of claim 17, wherein obtaining the indication comprises receiving an indication of a time period, and wherein deleting the one or more data objects comprises selecting the one or more data objects based on the time period.

19. The system of claim 17, wherein obtaining the indication comprises receiving an indication of a site identifier, and wherein deleting the one or more data objects comprises selecting at least a portion of the one or more data objects based on the site identifier.

20. The system of claim 17, wherein deleting the one or more data objects comprises using a routine that is browser agnostic and operating system agnostic.

21. The system of claim 17, wherein deleting the one or more data objects comprises deleting a data object stored by a version of the plug-in program that is associated with a different browser.

22. The system of claim 17, wherein deleting the one or more data objects comprises deleting a data object storing one or more settings for the plug-in program.

23. The system of claim 17, wherein the clear data event is caused by a browser shutdown event.

24. The system of claim 17, wherein the clear data event is user-initiated.

25. The system of claim 17, wherein the data processing device includes the computer storage device.
